(19) United States
(12) Patent Application Publication
(10) Pub. No.: US 2014/0150580 A1
(43) Pub. Date: Jun. 5, 2014

(54) ROTARY TO LINEAR TRANSMISSION

(71) Applicant: John McEntee, Boulder Creek, CA (US)

(72) Inventor: John McEntee, Boulder Creek, CA (US)

(21) Appl. No.: 14/082,160

(22) Filed: Nov. 17, 2013

Related U.S. Application Data
(60) Provisional application No. 61/797,287, filed on Dec. 1, 2012.

(51) Int. Cl. F16H 25/22

(52) U.S. Cl. CPC F16H 25/2214
USPC 74/89.34

(57) ABSTRACT

An apparatus for converting rotary motion to linear motion comprising: a cylindrical bore; a plurality of balls of uniform radius. The apparatus further comprises a rotor element, The rotor element further comprising a helical groove on the perimeter of the rotor element, wherein the helical groove comprises two ends and a race, wherein the race is configured to hold the plurality of balls in contact with a surface of the bore and is further configured to roll the ball in a helical groove path. The apparatus further comprises a recirculation conduit joining the two ends of the helical groove, wherein the conduit is configured to create a path for the plurality of balls and is further configured to allow the plurality of balls to remain in the helical groove during rotation of the rotor element.

### CROSS-REFERENCE TO RELATED APPLICATIONS

This application claims priority to U.S. Provisional Application No. 61/797,287, filed Dec. 1, 2012, entitled “Rotary to Linear Transmission”, which is incorporated by reference herein.

### INCORPORATION BY REFERENCE

All publications and patent applications mentioned in this specification are herein incorporated by reference to the same extent as if each individual publication or patent application was specifically and individually indicated to be incorporated by reference.

### FIELD OF THE INVENTION

This invention generally relates to systems and methods for mechanical assemblies.

### BACKGROUND OF THE INVENTION

Rotary-to-linear (RTL) transmissions are useful in mechanical systems where linear motions are required but motive power is provided by rotary motion such as shaft power produced by an electric motor, hand crank, or other rotary motion apparatus. Commonly, RTL devices are based on a helical screw principle where rotation of a shaft with external helical threads pushes or pulls a rotationally constrained nut that has matching internal threads, thus conveying the nut axially along the threaded rod. Lead screws and ball screws are common examples of this class of RTL device. RTL devices have practical applications in apparatus ranging from heavy industrial machinery to small precision instruments.

### SUMMARY OF THE INVENTION

In an example embodiment, an apparatus for converting rotary motion to linear motion includes a plurality of balls, a cylindrical bore, and a unique rotor. The rotor comprises one or more cylindrically helical grooves on an outside diameter of the rotor and one or more recirculation conduits joining ends of the cylindrically helical grooves. Rotation of the rotor with respect to the bore causes the balls, generally constrained by the helical groove, to roll along a bore wall in a helical path and convey the rotor axially along a bore's length.

In another example embodiment, an apparatus for converting rotary motion to linear motion includes a plurality of balls, a cylindrical bore, and a unique rotor. The rotor comprises one or more cylindrically helical v-shaped grooves on an outside diameter of the rotor and one or more recirculation conduits joining ends of the cylindrically helical grooves. Rotation of the rotor with respect to the bore causes the balls, generally constrained by the v-shaped helical groove, to roll along a bore wall in a helical path and convey the rotor axially along a bore's length without or with limited backlash.

In another example embodiment, an apparatus for converting rotary motion to linear motion includes a plurality of balls, a cylindrical bore, and a unique rotor. The rotor comprises one or more cylindrically helical v-shaped grooves on an outside diameter of the rotor and one or more recirculation conduits joining ends of the cylindrically helical grooves. A design angle of the v-shaped grooves is selected such that an axial load on the rotor amplifies a force of the balls against a bore wall; and increases traction between a ball's surface and a bore wall and limits the balls from slipping on a bore surface. Rotation of the rotor with respect to the bore causes the balls, generally constrained by the v-shaped helical groove, to roll along the bore wall in a helical path, and conveys the rotor axially along a bore's length.

In another example embodiment, an apparatus for converting rotary motion to linear motion includes a plurality of balls, a cylindrical bore, and one or more unique rotors. The rotors are each comprised of two half-sections. Each rotor half-section comprises one or more beveled segments which follow a cylindrically helical path, and one or more interconnecting channels joining ends of the beveled segments. In an interface between the rotor's two half-sections, the beveled segments create sides of one or more cylindrically helical v-shaped grooves and the interconnecting channels form recirculation conduits. Rotation of the rotor with respect to the bore causes the balls, generally constrained by the v-shaped helical groove, to roll along the bore wall in a helical path, and convey the rotor axially along a bore's length without or with limited backlash. The axial proximity between the rotor's two half-sections can control a force of the balls against a bore wall. Each pair of additional rotor half-section added to the assembly creates additional ball circuits on the rotor apparatus and more balls in contact with the bore wall.

In another example embodiment, an apparatus for converting rotary motion to linear motion includes a plurality of balls, a cylindrical bore, and a unique rotor comprised of two or more double-sided rotor half-sections, whereby each side of the rotor section comprises one or more beveled segments following a cylindrically helical path, and one or more recirculation channels joining ends of the beveled segments on each side. Assembling two or more rotor sections can create cylindrically helical v-shaped grooves on the rotor's outside diameter with interconnecting recirculation conduits at the interface between the double-sided rotor sections. Rotation of the rotor with respect to the bore causes the balls, generally constrained by the v-shaped helical groove, to roll along the bore wall in a helical path, thereby conveying the rotor axially along the bore's length without or with limited backlash. An axial proximity between the two double-sided rotor half-sections can control a force of the balls against a bore wall. Each additional double-sided rotor section added to the apparatus creates an additional ball circuit on the rotor assembly and, more balls in contact with the bore wall.

In another example embodiment, an apparatus for converting rotary motion to linear motion includes a plurality of balls, a cylindrical bore, and a unique rotor comprised of two or more rotor half-sections and ball spacer ring at each interstice between the rotor half-sections. Each side of the rotor section incorporates one or more beveled segments following a cylindrically helical path, and one or more recirculation channels joining ends of the beveled segments on each side. Assembling two or more rotor sections creates cylindrically helical v-shaped grooves on the rotor's outside diameter with interconnecting recirculation conduits at an interface between the double-sided rotor sections. Rotation of the rotor with respect to the bore causes the balls, generally constrained by the v-shaped helical groove, to roll along a bore wall in a helical path, and convey the rotor axially along the bore's length without or with limited backlash. An axial proximity between each pair of rotor sections can control a force of the balls against the bore wall. The interstitial ball spacer ring controls spacing between the balls. Each additional rotor half-section and ball spacing ring added to the assembly creates additional ball circuits on the rotor assembly, and more balls in contact with the bore wall.

In another example embodiment, an apparatus for converting rotary motion to linear motion includes a plurality of balls, exterior cylindrical tube that has been constrained (or partially constrained) in rotation, interior spindle element (such as a tube or shaft), and a unique rotor. The unique rotor incorporates one or more cylindrically helical grooves on an outside diameter of the rotor and one or more recirculation conduits joining ends of the cylindrically helical grooves. A ball spacing ring may be added to maintain uniform (or nearly uniform) ball spacing. The rotor and spindle element are coupled such that rotation of the spindle element causes the rotor to turn with respect to the exterior tube, causing the balls, generally constrained by the helical groove, to roll along a bore wall in a helical path, thereby linearly displacing exterior tube along an axis.

In another example embodiment, a telescoping apparatus for producing linear motion includes a plurality of balls, exterior cylindrical tube, and a motorized plunger element. The motorized plunger element is comprised of a device to produce rotary motion, such as an electric motor, coupled to a unique rotor. The unique rotor incorporates one or more cylindrically helical grooves on an outside diameter of the rotor and one or more recirculation conduits joining ends of the cylindrically helical grooves. A ball spacing ring may be incorporated to maintain uniform (or nearly uniform) ball spacing. Activation of a rotary source causes the rotor to spin within the exterior tube causing the balls, generally constrained by the helical groove, to roll along an inside of the tube wall in a helical path, thereby conveying the rotor and plunger element axially within the exterior tube.

### BRIEF DESCRIPTION OF THE FIGURES

FIGS. 1, 2A and 2B illustrate views of an example embodiment of a rotary to linear transmission.

FIGS. 3A, 3B, and 3C are diagrams illustrating v-shaped helical grooves and split-rotor halves.

FIGS. 4A, 4B, and 4C are diagrams illustrating several views of an example embodiment using a split-rotor concept with v-shaped grooves.

FIG. 5 shows several views of a thin-section rotor-half embodiment in accordance with an example embodiment.

FIGS. 6A, 6B, 6C, and 6D are diagrams illustrating an application of double-sided rotor halves in an assembly, in accordance with an example embodiment.

FIGS. 7A and 7B are diagrams illustrating a linear actuator assembly with exterior rotary source in accordance with an example embodiment.

FIGS. 8A and 8B are diagrams illustrating telescoping linear actuator assembly with integrated rotary source, in accordance with an example embodiment.

FIG. 9 is a diagram of a rotary to linear transmission illustrating rotor and tube elements in accordance with an example embodiment.

### DETAILED DESCRIPTION OF INVENTION

A detailed description of one or more preferred embodiments of the invention is provided below along with accompanying figures that illustrate by way of example the principles of the invention. However, it will be apparent to one skilled in the art that the example embodiments may be practiced without some of these specific details. In other instances, implementation details and process operations have not been described in detail, if already well known. Therefore, although the present invention has been described in terms of particular embodiments, it is not intended that the invention be limited to those embodiments. Modifications within the spirit of the invention will be apparent to those skilled in the art.

It is to be noted that the term generally constrained may refer to fully constrained or partially constrained.

A mechanical advantage produced by an RTL device may be controlled by a helical lead. The helical lead (lead) may be defined as the axial distance conveyed in a single rotation of the rotor. As the lead is reduced, the mechanical advantage is increased.

As will be demonstrated in the following discussion and illustrations, aspects of the invention provides a means of producing linear motion from rotary motion with high mechanical advantage in a single stage with little or no backlash.

Generally, an aspect of the invention includes an apparatus for converting rotary motion to linear motion comprising: 1) a cylindrical bore; 2) a plurality of balls of uniform radius; 3) a rotor element (i.e., rotor) comprising a helical groove on the perimeter of the rotor element, wherein the helical groove comprises two ends and a race, wherein the race is configured to hold the plurality of balls in contact with a surface of the bore and is further configured to roll the ball in a helical groove path; and 4) a recirculation conduit joining the two ends of the helical groove, wherein the conduit is configured to create a conduit path for the plurality of balls and is further configured to allow the plurality of balls to remain in the helical groove during rotation of the rotor element. The rotor element may comprise or be comprised of two half sections. The apparatus may comprise a ball spacing ring coupled to the rotor element. The helical groove is generally cylindrical. The helical groove may have a path that is less than 360 degrees and the helical groove path may comprise multiple wraps without interference between individual wraps. The helical groove may be v shaped. A wall of the helical groove may be concave or convex. A cross section of the helical groove may be rectangular or circular shaped. The helical groove may be at a right handed direction or at a left handed direction.

Further, the apparatus may comprise at least two cylindrical helical grooves, wherein each of the cylindrical helical grooves is of a v-shaped profile; and at least two interconnecting recirculation conduits. An angle of a side of the v-shaped groove may be configured to increase traction of the plurality of balls against a wall of the bore upon increase in an axial force on rotor element. The apparatus may have three cylindrical helical grooves comprised of three helical bevels. The bore may comprise an inner wall with a groove. The wall groove may be of a spiral shape configured to maximize repeatability. The apparatus may also comprise three regions configured to hold the plurality of balls in contact with the bore wall within a helical bevel region and further configured to guide the ball away from bore wall during recirculation. The rotor element may comprise a double sided half section having a helical bevel region and a conduit, wherein the helical bevel may be juxtaposed with the conduit. The rotor element may be of a shaped piece of thin material. In addition, the bore generally comprises a substantially smooth surface.

Moreover, the rotor element may be coupled to a structure at a center of the rotor element. The structure may be a spindle element, a linear actuator or a motorized plunger element. The apparatus may be coupled to an exterior cylindrical tube or apparatus may be inside the exterior cylindrical tube.

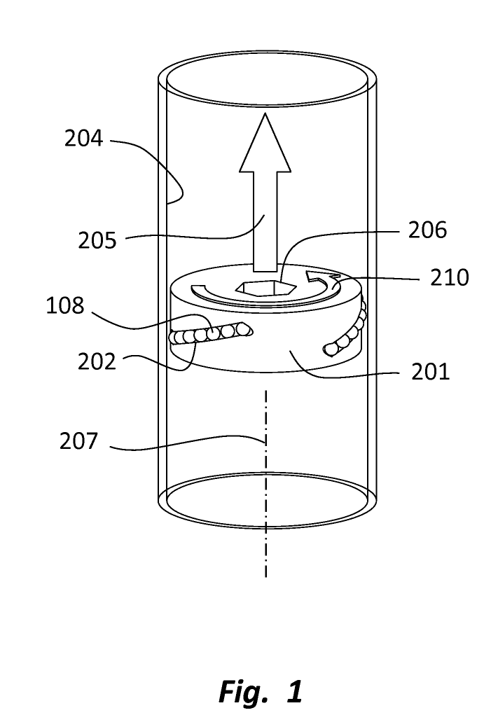

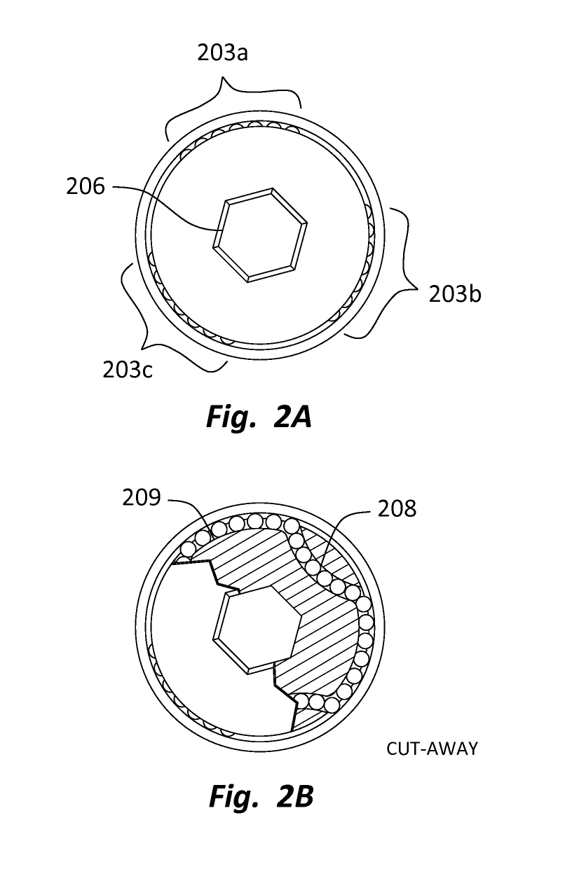

FIGS. 1, 2A and 2B show views of an example embodiment. In FIGS. 1, 2A and 2B, a unique rotor 201 incorporates one or more cylindrically helical groove(s) 202 on a perimeter of the rotor 201 and each helical groove provides a race for holding a plurality of balls 108 in contact with bore wall 204 (or bore surface 204) while constraining or allowing balls 108 to roll between the bore surface 204 and the race in a helical path; and further transporting the rotor 201 linearly along a bore axis 207 in a direction of arrow 205 by the rotation of rotor 201 in a direction of arrow 210. Recirculation conduits 208 join ends of the cylindrically helical grooves, creating a path for balls 108 to be conveyed between helical grooves 202 without (or minimal) bearing against bore wall 204. Helical grooves 202 remain populated by balls 108 as rotor element 201 rotates.

Example bore wall contact regions are shown in 203a, 203b, and 203c. Hexagonal coupling feature 206 may be added at the center of rotor to join the rotor 201 to a source or rotation such as a motor, hand crank, or any other rotary source. Reversing a direction of a rotation reverses a direction of the axial translation.

A maximum thrust that can be produced in the example embodiment may be limited by traction of balls 108 against bore wall 204. This traction is a function of a coefficient of friction between bore wall 204 and balls 108, multiplied by a total force applied to contact regions between balls 108 and bore wall 204. A maximum force that can be applied to each individual contact region between a ball 108 and bore surface 204 may be limited by strength, stiffness, and fatigue resistance of materials involved, but increasing a number of balls 108 in contact with bore 204 distributes a required load allowing greater traction as the number of contact regions increases.

Rotor 201 is shown to have right-hand helical grooves 202. Alternatively, left-hand helical grooves may also be utilized. Hexagonal coupling feature 206 may be included; alternatively, coupling to rotor 201 can be done in a number of ways including other coupling-feature profiles such as splines, squares, or further can be welded, adhesively bonded, manufactured with a shaft as a single part or any number of other attachment techniques known in the art. Balls 108 need not be standard bearing components but generally need only be substantially smooth spherical elements and have enough strength and stiffness to resist forces produced within a specific application. The material used in ball 108 can be metal, ceramic, glass, plastic, elastomer; and further may be solid, hollow, or a composite of different materials.

It will be understood that there are many ways to recirculate the balls 108. For example, in an alternate design, recirculation conduits 208 may move balls 108 from an end to a beginning of the same helical groove 202. Moreover, although each helical groove in FIGS. 1, 2A and 2B is shown to span approximately 60° of the total circumference of rotor 201, the helical groove 202 path may span any number of degrees or wrap the rotor multiple times with a recirculation conduit joining ends of helical groove 202. However, helical grooves with a path that is less than 360° have an advantage in designs producing high mechanical advantage because increasing the mechanical advantage of a screw-based RTL transmission of a specific diameter requires reducing the lead. In a multi-wrap design, the lead may not be less than a diameter of ball 108. Specifically, each wrap of the helical groove may clear a prior wrap so that the balls in adjacent wraps do not interfere with each other. If fractional circumference helical grooves are used, the helical grooves need not overlap, allowing the lead to be significantly reduced.

Moreover, in rectangular-shaped groove profiles shown in FIGS. 1, 2A and 2B, the ball is supported on rolling surface 209 and is guided by the sidewalls of helical grooves 202. Friction may be created as balls 108 rub against the walls of helical groove 202 reducing efficiency of the embodiment in FIGS. 1, 2A and 2B. In addition, helical grooves 202 may be wider than the diameter of balls 108 so that the balls may be free to roll in the groove, creating a clearance. This clearance between the balls and the groove sidewalls may create a source of backlash in an RTL system. A v-groove profile for the bearing race can eliminate or reduce the friction or clearance.

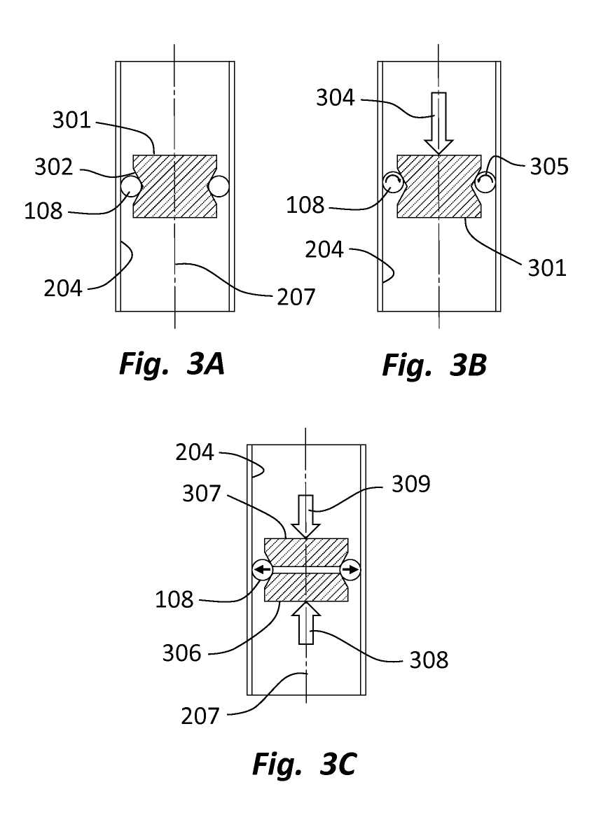

FIGS. 3A, 3B and 3C are cross-sectional diagrams showing several advantages of v-shaped profiles for helical grooves. FIG. 3A shows an assembly comprised of a rotor with v-shaped groove profile 302, a ball 108, and bore wall 204. The v-shaped groove profile 302 can hold balls 108 tightly in three-point contact between two walls of the v-shaped groove 302 and bore wall 204. As rotor 301 turns, ball 108 rolls efficiently along the v-shaped groove 302 with minimum friction and no (or minimum) backlash-producing clearance. FIG. 3B demonstrates wedge loading for traction amplification. In FIG. 3B, exaggerated for clarity, rotor 301 is axially displaced by a force in the direction of arrow 304. This displacement causes ball 108 to roll axially a small distance, rotating in the direction of arrow 305 against bore wall 204. Taking the coefficients of friction of the materials involved into account, an angle of the v-shaped groove sides can be designed so that any increase in the axial force on rotor 301 will cause an even greater increase in the traction of the balls 108 against bore wall 204, thus preventing ball 108 from slipping on the bore wall.

FIG. 3C shows a rotor comprised of two rotor half-sections 306 and 307. The rotor half-sections 306 and 307 are designed to split the v-shaped helical groove so that the proximity of the groove walls is adjustable. As forces in the direction of arrows 308 and 309 pinch the half-sections 306 and 307 together, the ball 108 is forced radially against bore wall 204. FIG. 3C shows adjustment capability; this adjustment capability can be used to compensate for reduced manufacturing precision, where half-sections 306 and 307 are adjusted and fixed by any technique known in the art such as an adjustment screw, welding, adhesive bonding and other techniques. The half-sections 306 and 307 can also be made to dynamically adjust by applying a sustained force pinching them together during operation of assembly in FIG. 3C. This pinching force can be applied by any method known in the art such as spring force, elastomeric force, magnetic force, pneumatic force, or other methods.

It will be appreciated that although the walls of the v-shaped profile in the helical grooves have been illustrated with straight walls, the grooves could be designed with sidewalls that have somewhat convex or concave side profiles.

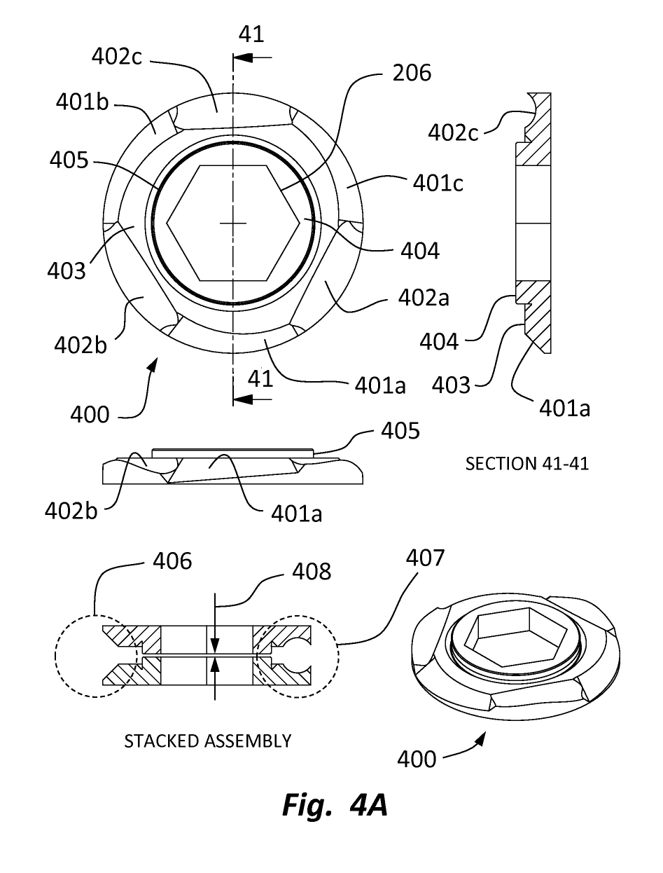

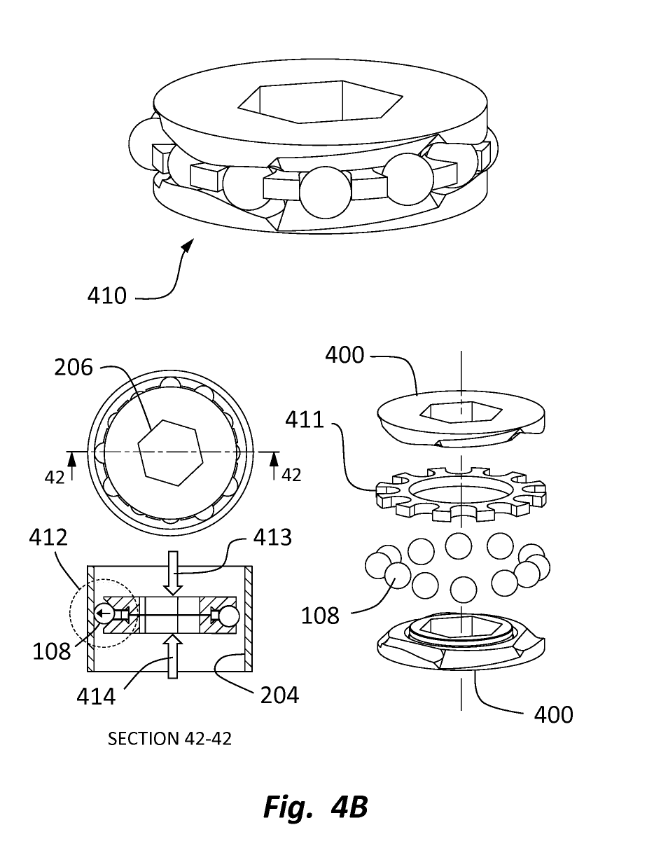

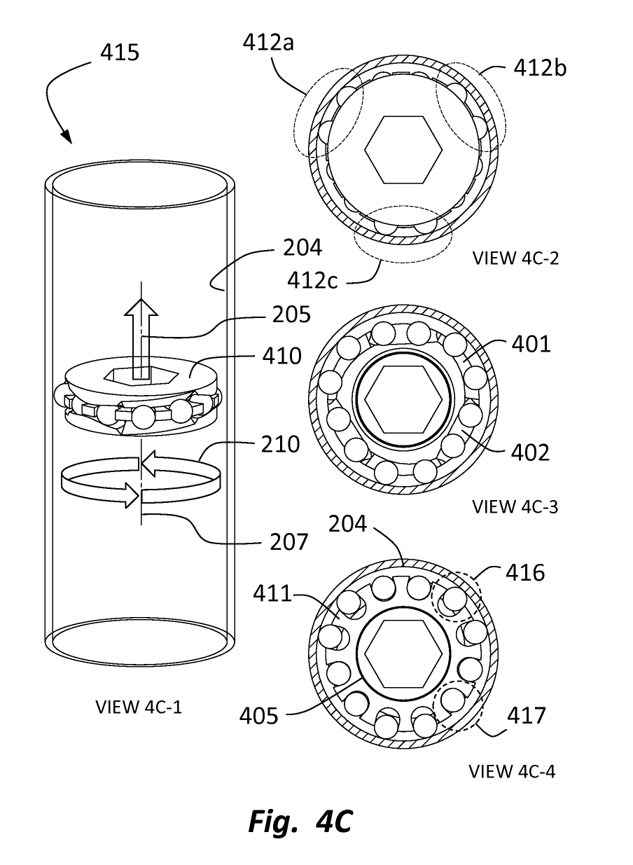

FIGS. 4A, 4B, and 4C show a rotor in another example embodiment, incorporating three cylindrically helical grooves with v-shaped profiles and three interconnecting recirculation conduits. As noted earlier, the rotor may have any number of cylindrically helical grooves on its diameter, interconnected with recirculation conduits, depending on a specific application of the rotor. In addition, although the v-shaped helical groove profile has many advantages, other profile shapes are possible.

FIG. 4A shows detailed views of a rotor half-section 400. In this embodiment, half-section 400 has three cylindrically helical bevels at positions 401a, 401b, and 401c and three interconnecting channels 402a, 402b, and 402c joining ends of respective bevels 401a, 401b and 401c. Hexagonal bore 206 at the center of rotor half-section 400 can be utilized to couple to a rotary source such as a motor, spindle shaft, etc. Rotor face 404 is projected above guide surface 403 creating bearing surface 405. When two rotor half-sections 400 are combined in a stacked assembly so that matching channels 402 and matching helical bevels 401 are aligned on opposing faces, the combined assembly creates three cylindrically helical split v-shaped grooves shown in a section view in region 406 and return conduit shown in region 407. It will be appreciated that spacing 408 between rotor half-sections 400 can be controlled to adjust the width of the v-shaped groove in the same manner as was shown in the embodiment in FIG. 3C.

Turning to FIG. 4B, assembled rotor 410 is comprised of two rotor half-sections 400, a plurality of balls 108, and may also include ball spacing ring 411. The balls 108 are distributed in a circuit within the perimeter of rotor assembly 410. During operation of the assembly in FIG. 4B, the balls 108 roll from a v-shaped groove section, through a recirculation conduit, back to a v-shaped groove section and continuing in this manner, thus continually circulating. A single rotor assembly 410 is referred to as having a single ball circuit. Optionally, ball spacing ring 411 can be included in the assembly as a means of reducing friction, controlling ball conveyance through the recirculation conduits, and preventing the balls 108 from jamming Ball spacing ring 411 may be designed to pivot on the two bearing cylindrical surfaces 405, constrained by guide surfaces 403; in this case a central bore of spacing ring 411 rides on cylindrical surfaces 405. Alternatively, the ball spacing ring may be guided on the bore wall or by balls 108. The applied axial forces 413 and 414 pinching rotor halves together controls a radial force between the balls 108 and the bore wall 204 as shown in region 412; this adjustment mechanism can be used to set and fix the proximity of half-rotors 400 as a final adjustment in assembly by applying the axial loads and fixing proximity 408 using any method known in the art such as screws, bonding, welding or other methods. In addition, rotor halves 400 can be made to dynamically adjust to variations in bore geometry by applying continuous compressive forces in the direction of arrows 413 and 414, pinching rotor halves 400 together during operation of the device. This compression force can be applied by any method known in the art such as spring force, elastomeric force, magnetic force, pneumatic force or another force.

FIG. 4C shows four views of the rotor-bore assembly 415. View 4C-1 shows a perspective view of assembly 415, which includes assembled rotor 410 and a tube with center bore 204. The tube is shown as transparent for clarity. Both rotor 410 and bore 204 share common centerline 207. As rotor 410 is rotated on axis 207 and in the direction of arrow 210, rotor 410 is conveyed in the direction of arrow 205 along axis 207. View 4C-2 is a top view of assembly 415 showing three regions 412a, 412b, and 412c where balls 108 contact the bore wall. View 4C-3 is a top view of assembly 415 with the top rotor half-section 400 and ball spacing ring 411 removed to show the balls 108 held against the bore wall 204 when within the helical bevel region but guided away from the wall while in the recirculation channels. View 4C-4 is the same view as 4C-3 with ball spacer ring 411 included, showing the required radial compliance of ball spacer ring 411 slots as balls 108 contact bore wall 204 in region 416 or withdraw from bore wall 204 as shown in region 417. To increase traction between the balls and the bore wall 204, more force must be applied to the total number of balls 108 in contact with the bore wall 204. As has been explained, additional balls can be added to the assembly to distribute the total force required. This can be easily accomplished by stacking more rotor assemblies 410 on a common spindle, thus creating additional ball circuits and increasing the number of balls in contact with bore wall.

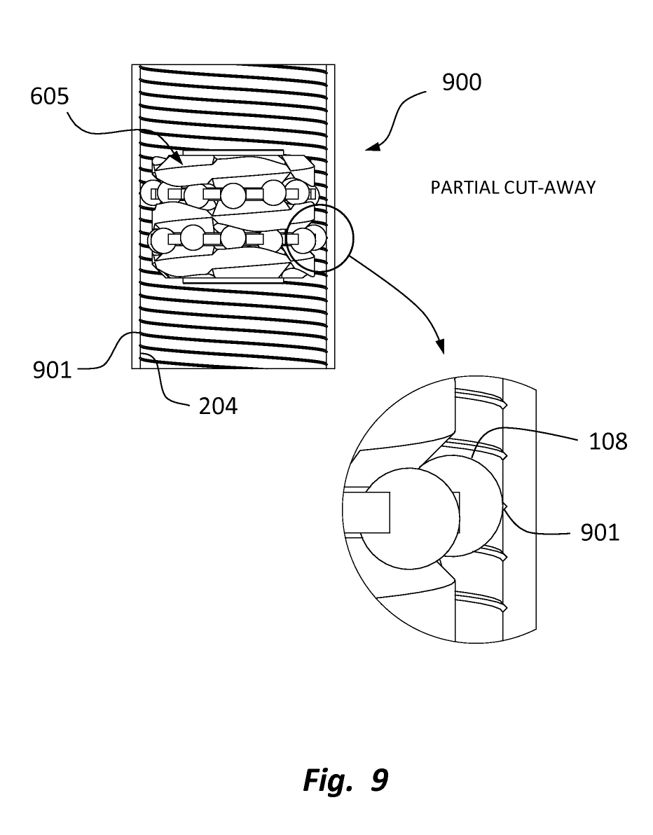

As shown in FIG. 9, bore wall 204 of assembly 900 may include one or more wall grooves 901 (in particular, cylindrically helical wall grooves) on an inner wall of the bore. In FIG. 9, the balls 108, which may normally ride on the substantially smooth bore wall 204, are guided by helical wall grooves 901, which direct the balls in a repeatable correlation to the rotor position. The wall grooves 901 in the bore wall element generally follow a same helical pitch as that used in the rotor element. In FIG. 9, there are three helical groves in a single ball circuit and the bore wall 204 may have three matching helical grooves. As in the previous examples, the rotor 605 is axially constrained in bore 204 by traction so the helical grooves need only be deep enough to create a preferential path for balls 108. The wall grooves 901 may be of spiral shape configured to maximize repeatability.

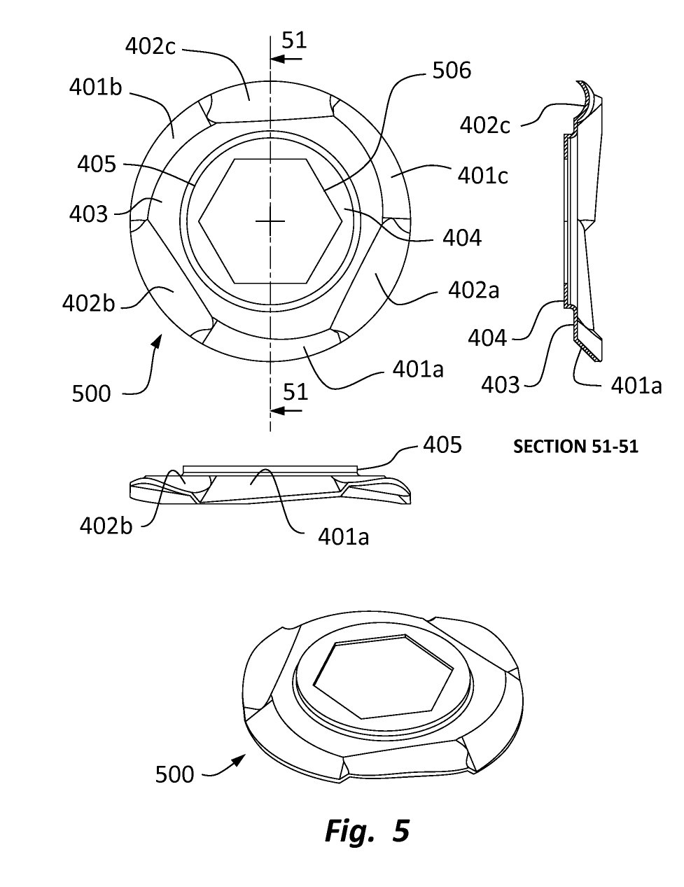

FIG. 5 shows detailed views of another embodiment of a rotor half-section. Rotor half-section 500 is made in a thin contoured cross section. In this way, the material used may be minimized, making the element only as thick as required to support the design loads in the device. Similar to rotor half-section 400, rotor half-section 500 has three cylindrically helical bevels at positions 401a, 401b, and 401c and three interconnecting channels 402a, 402b, and 402c, joining ends of the beveled segments. Optional hexagonal hole 506 at the center of rotor half-section 500 can be utilized to couple rotor half-section 500 to a rotary source such as a motor, spindle shaft and other rotary sources. Surface 404 is projected above guide surface 403 creating bearing surface 405 for optional ball spacing ring 411. This embodiment shown in FIG. 5 has advantages including lower mass, simplified manufacturing and lower cost. The embodiment shown in FIG. 5 can be made of any suitable material including metal, plastic, glass, ceramic, composite materials or other materials and further can be manufactured by any suitable method known in the art, such as forming, molding, stamping or other methods. In addition, the thin contoured cross-section of rotor half-section 500 can be designed to elastically bend under load as a spring making rotor half section 500 more tolerant of manufacturing imperfections.

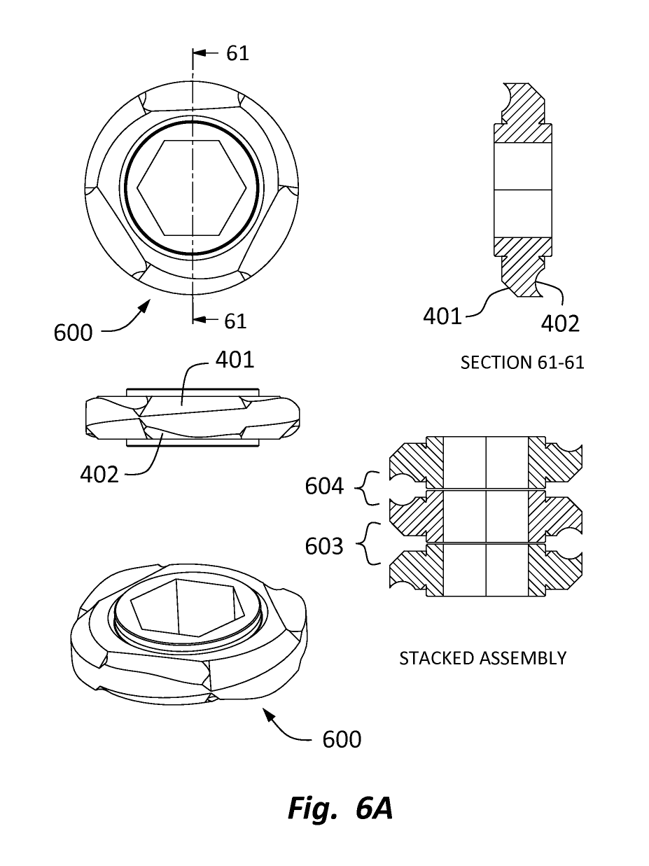

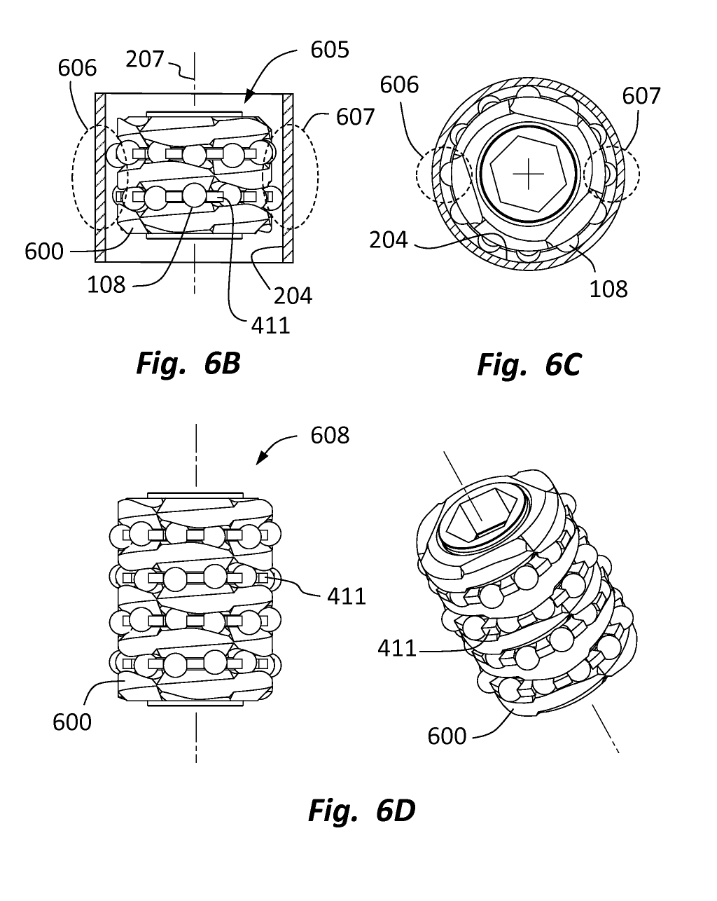

FIG. 6A shows another rotor embodiment that can simplify manufacturing rotor assemblies with two or more ball circuits. The double-sided rotor half-section 600 is similar to rotor half-section 400, but with helical bevels 401, conduit channels 402 and optional pivot bosses created on both faces which might reduce the number of rotor half-sections required in a multiple-circuit rotor assembly. In addition, the double-sided rotor half-section 600 may be approximately twice the thickness and may be stronger and stiffer and further may allow construction of the assembly in FIG. 6A with lower strength materials. As shown in Section 61-61, the features on the two faces of double-sided half-sections 600 can be angularly aligned so that bevels 401 are juxtaposed with conduit channels 402 on the opposite face. When stacked in a rotor assembly with multiple ball circuits, each pair of rotor half-sections 600 create v-shaped groove profiles as illustrated in region 603 and the approximately circular-profile recirculation conduits as illustrated in region 604.

Partially sectioned front view FIG. 6B and top view FIG. 6C depict two-circuit rotor assembly 605 shown within a representative bore section. This assembly in FIG. 6B and FIG. 6C incorporates three rotor half-sections 600, two ball spacing rings 411, and a plurality of balls 108. As represented in regions 606 and 607, v-shaped profile helical grooves and approximately circular-profile recirculation conduits are juxtaposed one over the other within the stacked assembly 605. As seen in FIG. 6C, this optional juxtaposed configuration distributes the ball contact areas more uniformly within the bore resulting in more uniform stresses on the bore 204 and less distortion. As in the other embodiments, rotation of rotor assembly 605 causes the rotor to be conveyed axially within bore 204 along common axis 207. FIG. 6D shows two views of a four-circuit rotor 608 comprised of five (5) half-sections 600, four (4) ball spacing rings 411, and a plurality of balls. Ball rotor 608 is shown without bore 204 for clarity.

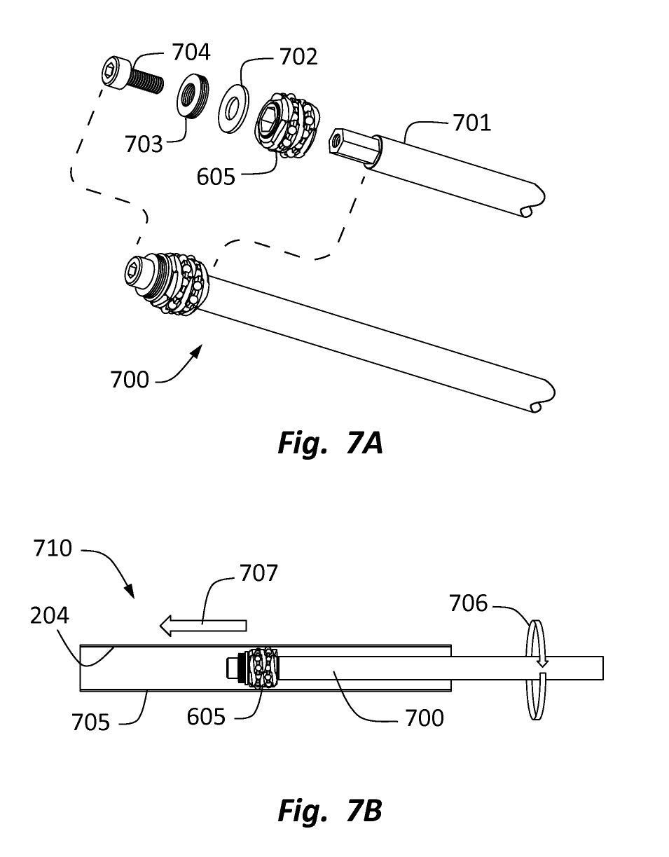

FIG. 7A shows two-circuit rotor and spindle assembly 700. As illustrated in the exploded view, rotor 605 is fastened to spindle 701 by screw 704. Bevel spring washer stack 703, and flat washer 702 provide a sustained compression force in rotor 605, pinching the rotor half-sections 600 together axially. FIG. 7B shows an embodiment 710 of a basic rotary to linear transmission comprised of spindle-rotor assembly 700 within tube section 705. The pinching force on the rotor half-sections 600 results in a radial force applied where balls 108 contact bore wall 204. When spindle-rotor assembly 700 is rotated in the direction indicated by arrow 706 and tube 705 is constrained in rotation, tube 705 is axially conveyed in the direction indicated by arrow 707. Reversing the direction of rotor rotation reverses the direction tube 705 is axially conveyed.

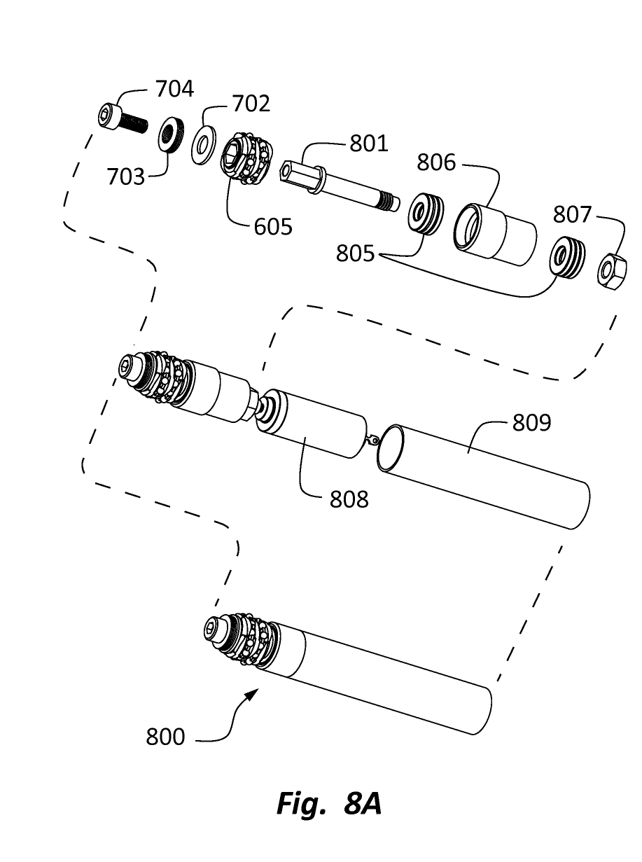

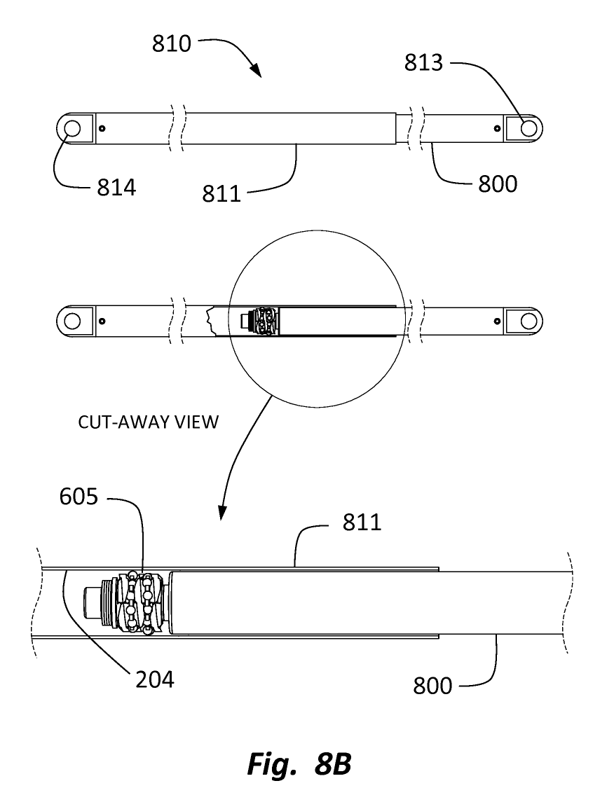

Referring to FIG. 8A and 8B, another embodiment of this invention is shown as a self-contained linear actuator. As illustrated in FIG. 8A, motorized plunger assembly 800 is comprised of rotor 605, bevel spring washer stack 703, and flat washer 702 fastened to spindle 801 with screw 704. Bevel spring washer stack 703 applies sustained axial compression force to rotor half-sections 600. Spindle 801 is supported in bearing mount 806 by thrust bearings 805, and this assembly is fixed with retaining nut 807. Spindle 801 is coupled to motor 808, which together with bearing mount 806 are affixed within tube 809. Powering motor 808 drives rotor 605. As shown in FIG. 8B, motorized plunger assembly 800 resides in bore 204 of track tube 811. Clevis mounts 813 and 814 are attached at the end of each tubes 809 and 811 to provide pivoting mount points for the actuator. A sustained axial compression force applied to rotor half-sections 600 by bevel spring washer stack 703 drives balls 108 radially against bore 204, thus providing traction at the contact points. The result is that motorized plunger assembly 800 is extended or retracted within bore 204 of track tube 811 when rotor 605 is driven in a clockwise or counter-clockwise direction. Reversing the motor direction reverses the axial direction of travel. Self-contained linear actuator 810 telescopes to extend or retract, thus pushing or pulling an attached mechanism.

Motorized plunger assembly 800 can be used in other mechanisms. The mechanism examples may be to close and open a valve, to drive a syringe pump, to drive a linear stage, or other uses to which a linear actuator may be applied. In these alternate uses, bore 204 may be integrated within the same block as other components of the mechanism and, therefore, need not exist in a separate component or tube. In addition, these actuators can be used in combination to produce multi-axis mechanisms.

It should be noted that although this mechanism is described as a rotary-to-linear transmission, like most RTL mechanisms, applying axial force can cause the rotor to turn and, therefore, it can be made to operate in reverse where rotary motion is produced by linear motion.

Although the foregoing example embodiments have been described in some detail for purposes of clarity of understanding, it will be apparent that certain changes and modifications may be practiced within the scope of the appended claims. Accordingly, the example embodiments are to be considered as illustrative and not restrictive, and the invention is not to be limited to the details given herein, but may be modified within the scope and equivalents of the appended claims.

What is claimed is:

1. An apparatus for converting rotary motion to linear motion comprising:
a cylindrical bore;
a plurality of balls of uniform radius;
a rotor element comprising a helical groove on a perimeter of the rotor element, wherein the helical groove comprises two ends and a race, wherein the race is configured to hold the plurality of balls in contact with a surface of the bore and is further configured to roll the ball in a helical groove path; and
a recirculation conduit joining the two ends of the helical groove, wherein the conduit is configured to create a conduit path for the plurality of balls and is further configured to allow the plurality of balls to remain in the helical groove during rotation of the rotor element.

2. The apparatus of claim 1, wherein the helical groove is cylindrical.

3. The apparatus of claim 1, wherein the helical groove path is less than 360 degrees.

4. The apparatus of claim 1, wherein the helical groove path comprises multiple wraps without interference between individual wraps.

5. The apparatus of claim 1, wherein the helical groove is v-shaped.

6. The apparatus of claim 5, wherein a wall of the helical groove is convex.

7. The apparatus of claim 5, wherein a wall of the helical groove is concave.

8. The apparatus of claim 1, wherein the apparatus comprises:
at least two cylindrical helical grooves, wherein each of the cylindrical helical grooves is of a v-shaped profile; and
at least two interconnecting recirculation conduits.

9. The apparatus of claim 8, wherein each of the three cylindrical helical grooves is comprised of a helical bevel.

10. The apparatus of claim 1, wherein the rotor element comprises two half sections and wherein the apparatus comprises a ball spacing ring.

11. The apparatus of claim 1, wherein the surface of the bore comprises a wall groove.

12. The apparatus of claim 11, wherein the wall groove is of a spiral shape configured to maximize repeatability.

13. The apparatus of claim 1, wherein the apparatus comprises at least one region configured to hold the plurality of balls in contact with a wall of the bore within a helical bevel region and further configured to guide the plurality of balls away from the bore wall during recirculation.

14. The apparatus of claim 1, wherein the rotor element comprises a double sided half section having a helical bevel region and a conduit.

15. The apparatus of claim 1, wherein the rotor element is coupled to a structure at a center of the rotor element.

16. The apparatus of claim 15, wherein the structure is a spindle element.

17. The apparatus of claim 15, wherein the structure is a linear actuator.

18. The apparatus of claim 15, wherein the apparatus is coupled to an exterior cylindrical tube.

19. The apparatus of claim 1, wherein a cross section of the helical groove is rectangular shaped.

20. The apparatus of claim 1, wherein a cross section of the helical groove is circular shaped.

21. The apparatus of claim 1, wherein the helical groove is at a right handed direction

22. The apparatus of claim 1, wherein the helical groove is at a left handed direction.

23. The apparatus of claim 5, wherein an angle of a side of the v-shaped groove is configured to increase traction of the plurality of balls against a wall of the bore upon increase in an axial force on the rotor element.

24. An apparatus for converting rotary motion to linear motion comprising:
a cylindrical bore;
a plurality of balls of uniform radius;
a rotor element comprising a helical groove on a perimeter of the rotor element, wherein the helical groove comprises two ends and a race, wherein the race is configured to hold the plurality of balls in contact with a surface of the bore and is further configured to roll the ball in a helical groove path, and further wherein the rotor element comprises two half sections; and
a recirculation conduit joining the two ends of the helical groove, wherein the conduit is configured to create a conduit path for the plurality of balls and is further configured to allow the plurality of balls to remain in the helical groove during rotation of the rotor element.

25. An apparatus for converting rotary motion to linear motion comprising:
a cylindrical bore;
a plurality of balls of uniform radius;
a rotor element comprising a helical groove on a perimeter of the rotor element, wherein the helical groove comprises two ends and a race, wherein the race is configured to hold the plurality of balls in contact with a surface of the bore and is further configured to roll the ball in a helical groove path;
a ball spacing ring coupled to the rotor element; and
a recirculation conduit joining the two ends of the helical groove, wherein the conduit is configured to create a conduit path for the plurality of balls and is further configured to allow the plurality of balls to remain in the helical groove during rotation of the rotor element.
